(19) United States
(12) Patent Application Publication
(10) Pub. No.: US 2006/0282342 A1
(43) Pub. Date: Dec. 14, 2006

(54) Image-based inventory tracking and reports

(76) Inventor: Leigh Chapman, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/123,810

(22) Filed: May 6, 2005

(51) Int. Cl. G06Q 10/00

(52) U.S. Cl. 705/28

(57) ABSTRACT

In various embodiments, the present invention provides methods and systems for using images as a basis for creating and organizing records in an inventory database. From the user's perspective, the image is the primary key to the inventory database. By selecting and moving images representing items in the inventory, the user can create and change records in the database. The user interface allows the user to add records of items, organize views of the data, and modify records of items all through the user's interaction with images.

### BACKGROUND

This invention relates to systems and methods of creating and maintaining inventories. Inventories are used, for example, in homes and in businesses. An inventory in the context of a home can be used to maintain an itemized list of objects in one's possession. An inventory in the context of a business can be used to maintain a record of the goods and materials in stock. Inventories can be stored in databases where each record corresponds to one item. The database may also store descriptive information about each item, such as purchase date, price, current value, and the like. By keeping the inventory current, users can quickly access a summary of their belongings, enabling them either to use the information themselves to make decisions or to share this information with other entities.

There are at least two common reasons to create inventories. First, a person or business may want to obtain insurance to cover certain assets owned by the person or business. An inventory helps the person or business to decide on the proper amount of coverage to request. Secondly, most insurance providers require an inventory of objects lost or damaged when a policyholder makes a claim for reimbursement for those objects covered by the policy. Generating an inventory from scratch after items have been stolen or destroyed is a process that can be hampered by fading or failing memories. Thus, a policyholder may fail to submit a claim that would fully compensate the policyholder for the loss. Moreover, any delay caused by the process of generating the inventory from scratch after the fact adds to the period of time during which the policyholder must survive without reimbursement. Additionally, in the case of loss, a policyholder may not have any remaining evidence of ownership of the item for which reimbursement is sought, which may further delay or reduce reimbursement. There are additional reasons to generate and maintain an inventory, particularly in the business context. Inventories are useful, for example, in monitoring raw materials usage and finished goods available in stock, and for a variety of accounting purposes.

To respond to the demand for assistance in generating and maintaining inventories for these and other reasons, there has been a proliferation of tools available on the market to assist users in preparing inventories. Examples of available inventory programs are AssetManage Home Inventory by Liberty Street Software (available at http://www.libertystreet.com/Asset-Home-Inventory.htm), Everything I Own, by Mycroft Computing (available at http://www.mycroftcomputing.com/eiown.html), Frostbow Home Inventory by Frostbow Software (available at http://frostbow.com/products/home_inventory.html), and QuickBooks: Point of Sale 4.0 (available at http://quickbooks.intuit.com). Existing tools require users to manually enter information in order to provide even a basic description of each item. The perceived hassle of having to manually enter data about every object in a user's house, for example, is daunting in terms of time and resource expenditure. Some tools allow users to append pictures they have taken of their property to manually-entered records in order to provide a more complete description of their belongings without additional typing. However, the existing tools still require that a user type descriptive information about an item in order to store a record for an item in the inventory database.

### SUMMARY

In various embodiments, the present invention provides methods and systems for using images as a basis for creating and organizing records in an inventory database. From the user's perspective, the image is the primary key to the inventory database. By selecting and moving images representing items in the inventory, the user can create and change records in the database. The user interface allows the user to add records of items, organize views of the data, and modify records of items all through the user's interaction with images.

The creation of a new record in the inventory database is initiated by a user selecting an image to represent an item to be added to the inventory and moving it into the inventory list. The inventory list can be arranged in a hierarchy by an attribute of the items, such as the location of the item within the home, for example. The home inventory program stores a new record for the item, the record including reference to a copy of the selected image, a unique identifier for the item, and a value for the attribute determined from the placement of the image into the hierarchical inventory list.

A user can modify a record stored for an item in the inventory by moving the image representing the item within the user interface of the home inventory program. The record stored for the item is automatically updated to reflect changes in the attributes of the item determined by the user's movement of the image within the hierarchical inventory list.

### BRIEF DESCRIPTION OF THE DRAWINGS

FIG. 1 is an illustration of one embodiment of a user interface of a Home Inventory software product displaying Locations.

FIG. 2 is an illustration of one embodiment of a user interface of a Home Inventory software product displaying Categories.

FIG. 3 is an illustration of one embodiment of a user interface of a Home Inventory software product displaying items in a specific Location.

FIG. 4 is an illustration of one embodiment of a user interface of a Home Inventory software product for displaying the image representing a specific item in the Inventory.

FIG. 5 is an illustration of one embodiment of a user interface for an Item Info window of a Home Inventory software product.

FIG. 6 is an illustration of one embodiment of a user interface for selecting an image file from a menu in a Home Inventory software product.

FIG. 7 is an illustration of one embodiment of a user interface of a Home Inventory software product displaying several sample images from a sample image file.

FIG. 8 is an illustration of one embodiment of a user interface of a Home Inventory software product for displaying Insurance Policies.

FIG. 9 is an illustration of one embodiment of a user interface of a Home Inventory software product for displaying and editing detailed information about an insurance policy.

FIG. 10 is an illustration of one embodiment of an Inventory Detail Report.

FIG. 11 is an illustration of one embodiment of an Inventory Summary Report.

FIG. 12 is an illustration of one embodiment of tables showing the data structure of the Home Inventory database.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

According to one embodiment, the present invention provides a user interface for using images as a basis to create and organize records in an inventory database and to generate reports using those records. In this image-based inventory system, users identify items in the inventory by reference to the stored image of the item. The present invention can be implemented in personal or commercial financial management software packages including, for example, accounting or tax preparation software. The present invention, in other embodiments, can also be implemented as a stand-alone application outside of a financial management software package. Alternatively or additionally, the application can be remotely hosted and accessed over a network, such as the Internet, a LAN, a WAN, a wireless network, a private network or a virtual private network. The present invention will be described in the context of a Home Inventory software program as a feature included in a financial management software package, such as Quicken® or QuickBooks® by Intuit, Inc. of Mountain View, Calif., or Microsoft Money by Microsoft Corporation of Redmond, Wash., that has been loaded onto a user's computer. In the following examples, the financial management software package is included on a computer running a version of Mac OS developed by Apple Computer, Inc. of Cupertino, Calif. The present invention, in other embodiments, can be adapted to apply to Windows, various flavors of Linux, UNIX, Palm OS, and other operating systems. It will be readily understood by those ordinarily skilled in the art that the software products, methods and systems could also be applied in business inventories or other inventory contexts outside the home all without departing from the teachings of the invention disclosed herein.

I. User Interface

In general, the following discloses a user interface for a Home Inventory software product. Several Figures are presented as screen shots depicting examples of the user interface as it might appear on a display screen or other output device. The particular screen layouts, appearance, and terminology as depicted and described herein, are intended to be illustrative and exemplary, and in no way limit the scope of the invention as claimed.

The user interface allows the user to add records of items, organize views of the data, and modify records of items all through the user's interaction with images that represent items in a home inventory. The underlying inventory data file is organized as follows. For each item in the inventory, a separate record in the database is maintained. In one embodiment, each record comprises an image, a description, a location, a category, and optionally other fields relating to the specifics of the purchase and insurance coverage of the item. These specifics may include a purchase price, a purchase date, a purchase location, payment method, replacement cost, resale value, insurance policy, make/model, serial number, and other notes. In some embodiments, the inventory record for an item optionally includes or is linked to PDF, JPEG, GIF, bitmap, TIFF or other suitably formatted image files of documents relating to the item such as purchase receipt, appraisals, repair records and receipts, and the like. Also optionally, the inventory record includes or is linked to additional images of the item, such as top, side, or interior views of the item used to supplement the visual record of the item in the inventory. In some embodiments, the record for an inventory item is stored with a link to the register entry reflecting the purchase of the item in a related financial management software application. In this way, the user can access detailed transaction-based information stored by the financial management program from the image-based home inventory user interface through this cross-reference.

Two of the attributes stored for each item in the inventory, location and category, are particularly useful in sorting the records of the items in the inventory. Location refers to the physical location where the object resides. For example, in the home context “living room,” “dining room” and “bathroom” are locations. In another context, the location list can include location names appropriate for that context, whether in a home or at a business. Category refers to the type of item, such as “appliances” “collectibles” and “electronics” for example. The user can change or edit any of the item's attributes stored in the item's record.

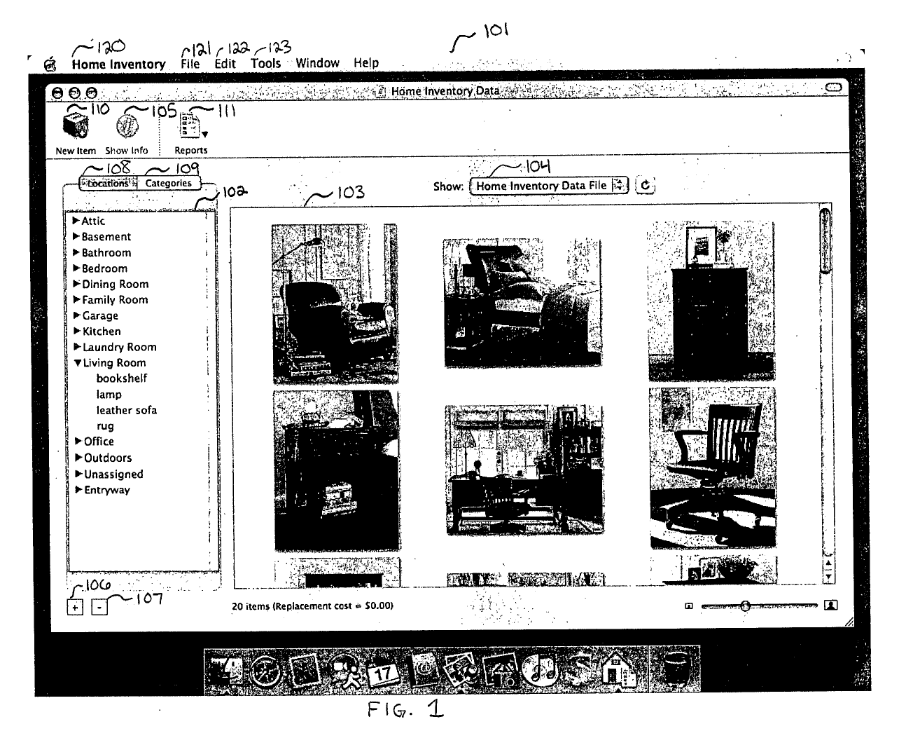

Referring to FIG. 1, there is shown a user interface 101 of a home inventory system. The user interface for the home inventory system is divided into two main sections: the locations/categories pane 102 and the main workspace 103. Additionally, the user interface includes a Show menu 104, a Show Info button 105, and Add 106 and Delete 107 buttons.

Locations/Categories pane. Referring to FIG. 1, on the left of the main workspace 103 is the locations/categories pane 102, 202. The user selects whether to view Locations or Categories by selecting between the Locations tab 108 and Categories tab 109 at the top of the pane. Locations and Categories contains a default list of locations or categories in one embodiment. For example, locations on the default list may include: Attic, Basement, Bathroom, Bedroom, Dining Room, Family Room, Garage, Kitchen, Laundry Room, Living Room, Office, Outdoors, Entryway, and Unassigned. Categories on the default list may include: Appliances, Arts and Decorations, Clothing, Collectibles, Computer Equipment, Electronics, Furnishings, Garage and Yard, Jewelry, Kitchenware, Linens, Personal Care, Sports and Recreation, Vehicles, and Other. Locations and categories are editable and configurable by the user.

The Locations pane 102 displays a view of the items stored in the inventory database sorted by location. In some embodiments, the hierarchical structure of the Locations list allows the user to drill down to reveal the description of each item having a given location. For example, by drilling down on the location “Living Room” the description of each item having “Living Room” as the value in the location field of the item's database record is displayed. In the example depicted in FIG. 1, bookshelf, lamp, leather sofa, and rug are displayed under Living Room because Living Room is the location stored for those items in their records. The hierarchy of locations can be defined and modified by the user.

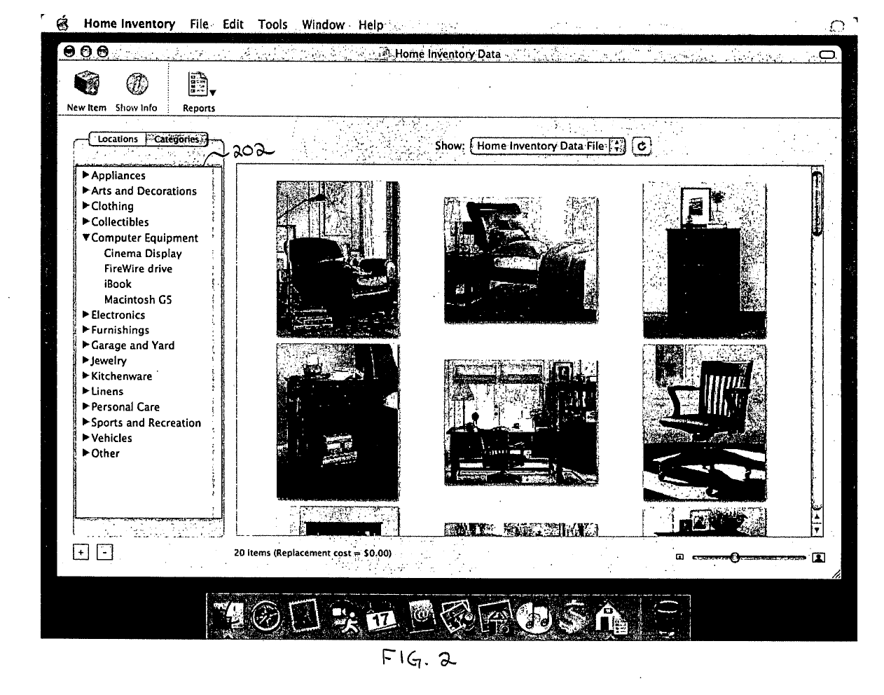

Referring to FIG. 2, similarly, the Categories pane 202 displays a view of the records stored in the inventory database sorted by category. The hierarchical structure of the Categories list allows the user to drill down to reveal the description of each item having a given category. In the example depicted in FIG. 2, by drilling down on the category “Computer Equipment” the description of each item having “Computer Equipment” as the value in the category field of the item's database record is displayed. The hierarchy of categories can be defined and modified by the user as well.

Main Workspace. Returning to FIG. 1, the main workspace 103 is an image browser pane used to display images to the user. For example, when a user selects one of the locations or categories from the list of locations or categories in the locations/categories pane 102, the images associated with each record having the selected value for the location or category field are displayed in the main workspace 103. As another example, when a user selects an image source file from the Show menu 104, thumbnails of the images in the image source file are displayed in the main workspace 103. The thumbnails of images are links to full-sized images. The user selects a thumbnail of an image to then display the full-sized version of the image in the main workspace 103.

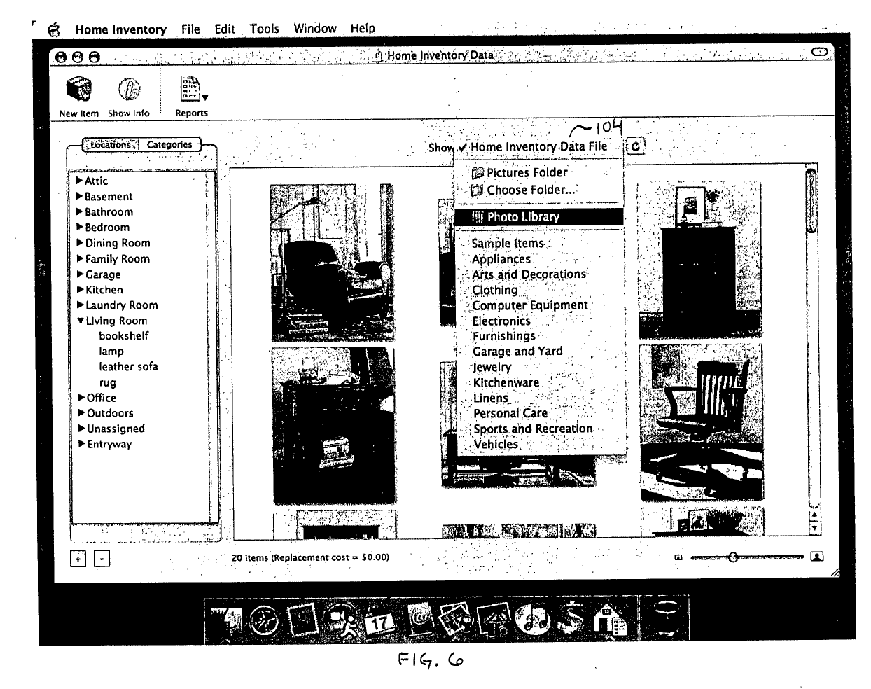

Show menu. The Show menu 104 is a menu that displays options for image source files. Image source files include any image files accessible by the Home Inventory program. For example, image sources may be image files from a photolibrary such as a photolibrary created by a user containing pictures taken with a digital camera, image files downloaded from remote locations, as well as files of sample images that are optionally included with the Home Inventory program. FIG. 6 shows the Show menu 104 as it appears in the user interface when selected by the user. The user browses for an image file from the list of image source files in the Show menu 104. When the user selects an image source file, the image source file is opened into the main workspace 103, and thumbnails of the images in the image source file are displayed.

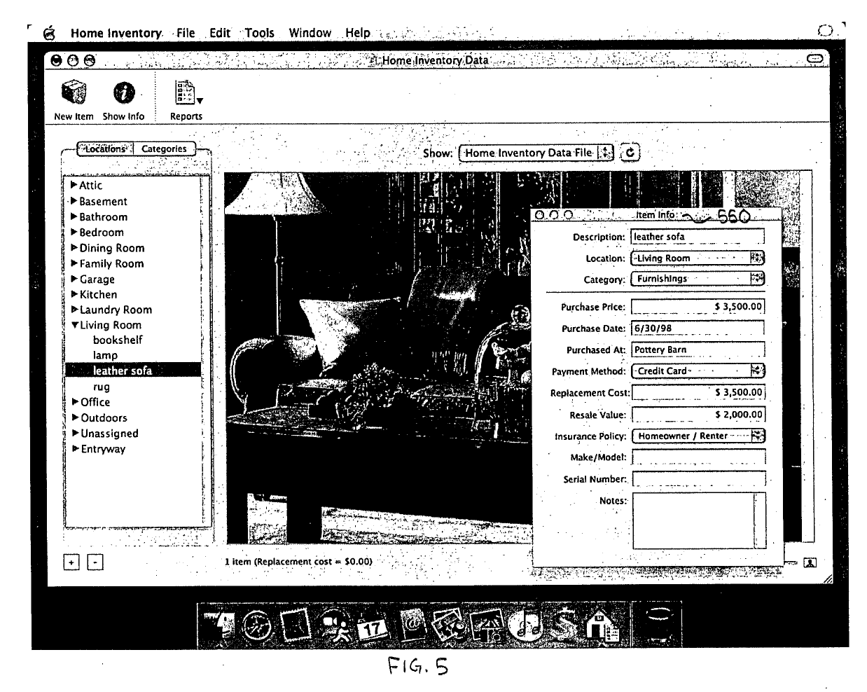

Item Info window. Referring to FIG. 5, the Item Info window 550 displays information stored in the item's record in the inventory database. Within the Item Info window 550, a user can change any or all of the information stored in the item's record. For example, the user can change the description of the item, the location, the category, or any of the specific information relating to the purchase and insurance coverage of the item such as purchase price, purchase date, purchase location, serial number, insurance policy and the like.

Add and Delete Buttons. The Add button 106 and Delete button 107 allow the user to easily add or subtract locations or categories from the list of categories or locations. When the user selects the add button 106 and categories are displayed, a new untitled category is added to the category list in the categories pane 202. When the user selects the add button and locations are displayed, a new untitled location is added to the location list in the locations pane 102. When the user selects a location or category and then selects the delete button 107 and the user confirms the action, the location or category is deleted from the list and all items having that location or category are deleted from the inventory database. When the user selects a specific item from the locations/categories pane 102, 202, only that item is deleted from the inventory database.

III. Inventory Data Files

Create a New Inventory File

A user can create a new inventory file by selecting New File from the File menu 121. The user is then prompted to enter a name for the file. In one embodiment, the default name is “Home Inventory Data”. If file by this name already exists in the default location, then the next available number is added to the name. For example, the next file is “Home Inventory Data 2” by default, then “Home Inventory Data 3” and so on. In other embodiments, the default name can be any alphabetic string or any alphanumeric string. In some embodiments default names are randomly assigned, in other embodiments the default names are assigned by the user, and in still other embodiments default names are sequentially assigned.

Open an Inventory File

To open an inventory file, the user selects Open File from the File menu 121. The user then selects the file to be opened, and selects Open. In one embodiment, a user cannot have more than one data file open at a time. Thus, if the user has a data file open with changes that have not been saved when a new file is selected for opening, Home Inventory prompts the user to indicate if the user would like to save the changes to the currently open file. When the user selects Save, the current file is closed and the newly selected file is opened.

Save an Inventory File

After a user makes changes to records in an inventory file, those changes must be saved prior to exiting Home Inventory in order for them to appear the next time the inventory data file is opened. To protect against accidental loss of changes, Home Inventory prompts the user to indicate if the user would like to save the changes to the currently open file prior to closing it. Users can save work in progress by selecting Save from the File menu 121.

Close an Inventory File

To close a Home Inventory file, the user selects Close Window from the File Menu 121 or Quit Home Inventory from the Home Inventory Menu 120. After a user makes changes to records in an inventory file, those changes must be saved prior to exiting Home Inventory in order for them to appear the next time the inventory data file is opened. To protect against accidental loss of changes, Home Inventory prompts the user to indicate if the user would like to save the changes to the currently open file prior to closing it.

Creating the Key to the Inventory Data File

Additions to the inventory are instigated by the user selecting an image to represent the item from a displayed array of images and dragging the image to the list of locations or categories. Changes to a record for an item in the inventory are also preferably instigated by the user selecting the image representing the item from a displayed array of images. For example, the location and category fields of a record for an item in the inventory are preferably instigated by the user selecting the image representing the item from a displayed array of images and dragging the image to the new location or category in the displayed list in the locations/categories pane 102, 202. Thus, from the user's perspective through the user interface, the images stored for each item are the primary key to the inventory database. In other words, an image uniquely identifies the inventory database record for an item. The following describes one embodiment of an underlying database architecture that supports the use of images as the primary key within the user interface.

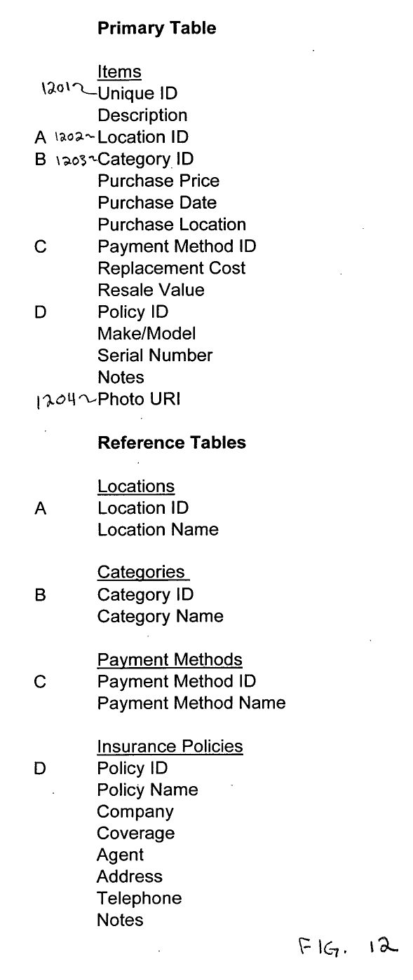

Referring to FIG. 12, there is shown an example of one embodiment of the data structure of the inventory database. FIG. 12 shows the fields of a primary table and four reference tables. Letters A-D identify the keys shared between the tables. When an image representing an item is added to an inventory data file, a new record is added to the primary table and a new unique identifier is generated. In the example shown in FIG. 12, the primary table stores the unique identifier for each item in the inventory in the Unique ID field 1201. In some embodiments, ID numbers in the form of unsigned long integers are assigned consecutively to incoming items. To facilitate the illusion that the images are being used as the primary key to the database, in some embodiments ID numbers are not displayed to the user. As described above, the user preferably selects and modifies a record in the database by selecting the image representing the item in the inventory.

IV. Inventory Items

Adding an Item

Users can add items to the Inventory in any of three ways: adding a personalized image from an image folder; adding a sample item as a placeholder for a personalized image; or adding an item for which no image is yet available. In each case, it is the selection or creation of an image to represent the item that instigates the creation of the record for the item in the inventory data file.

Adding a personalized image from an image folder. Referring to FIG. 6, the user selects an image folder to open from a menu of available image folders displayed in the Show menu 104. When the user selects an image folder, thumbnails of the images in the selected image folder appear in the main workspace 103. The user selects an image that the user wants to represent an item to be stored in the inventory file. Preferably, the user drags the selected image from the main workspace to its location or category. When the user drags the image representing the item to the desired location or category and releases the item, a new record is generated in the primary table of the inventory database and a copy of the image is saved in an inventory data file. The new record in the primary table is populated with a generated unique identifier for the new item, and a reference to the copy of the image selected by the user to represent the new item is added to the Photo URI field 1204. In addition, the location ID field 1202 or category ID field 1203 of the new record is assigned a value based on the location or category in the locations/categories pane 102, 202 to which the user dragged the image representing the new item. Otherwise, the location ID field 1202 and category ID field 1203 contain default values. For example, if a user wants to add a chair to the inventory of items in the user's living room and the user has an image of the chair in an image folder accessible through the Show menu 104, the user selects the image folder containing the image of the chair. Thumbnails of the images in that folder appear in main workspace 103. The user then selects the thumbnail image of the chair, and drags the image to the locations/category pane 102, 202. The user drops the image of the chair onto the “Living Room” label in the list of locations. The action of dropping an image onto a label in the locations/category pane triggers the generation of a new record in the inventory database and the storing of a copy of the image in an inventory data file. The new record for the chair in the inventory database contains a unique identifier in the Unique ID field 1201 for the record and a reference to the copy of the image of the chair in the inventory data file in the Photo URI field 1204. In addition, the location ID field 1202 of the record for the chair is filled with a code representing the location of “Living Room.”

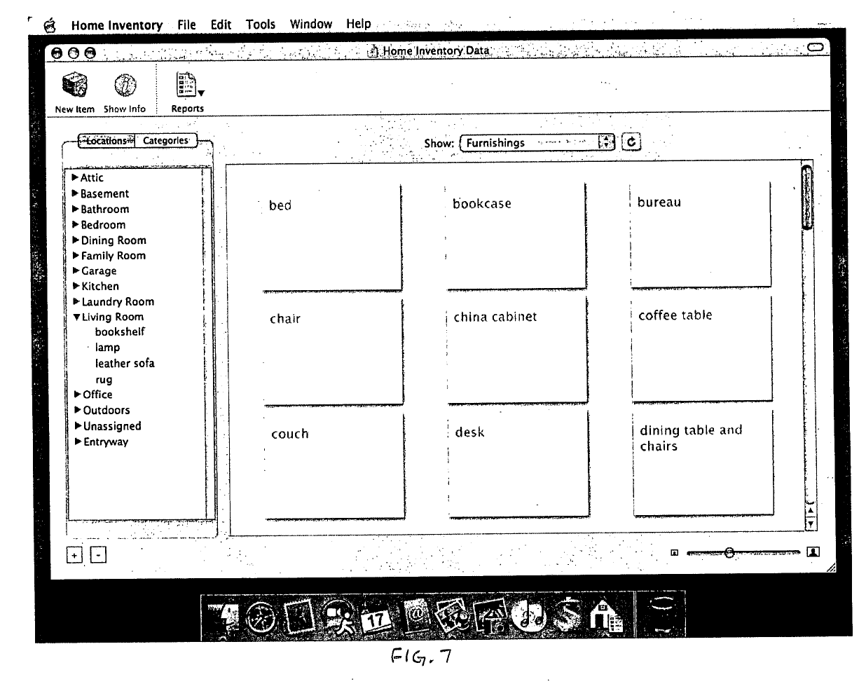

Adding a sample image as a placeholder for a personalized image. A user may wish to insert a sample image as a placeholder for a personalized image that the user has yet to acquire. The process is largely the same as described above for adding a personalized image from an image folder. The user selects the sample image folder to open from the Show menu 104 containing the available image folders. Thumbnails of the sample images in the selected sample image folder appear in the main workspace. FIG. 7 shows examples of sample images from a “Furnishings” sample image folder. The user then selects a sample image that the user wants to represent an item to be stored in the inventory file. The user drags the selected sample image from the main workspace to the appropriate location or category. When the user drags the sample image to a location or category, a new record is generated in the primary table of the inventory database and a copy of the sample image is saved in an inventory data file. As described above, the new record in the primary table is populated with a generated unique identifier for the new item, and a reference to the copy of the sample image is added to the Photo URI field 1204. In addition, the location ID field 1202 or category ID field 1203 of the new record is assigned a value based on the location or category in the locations/categories pane 102, 202 to which the user dragged the sample image. Otherwise, the location ID field 1202 and category ID field 1203 contain default values.

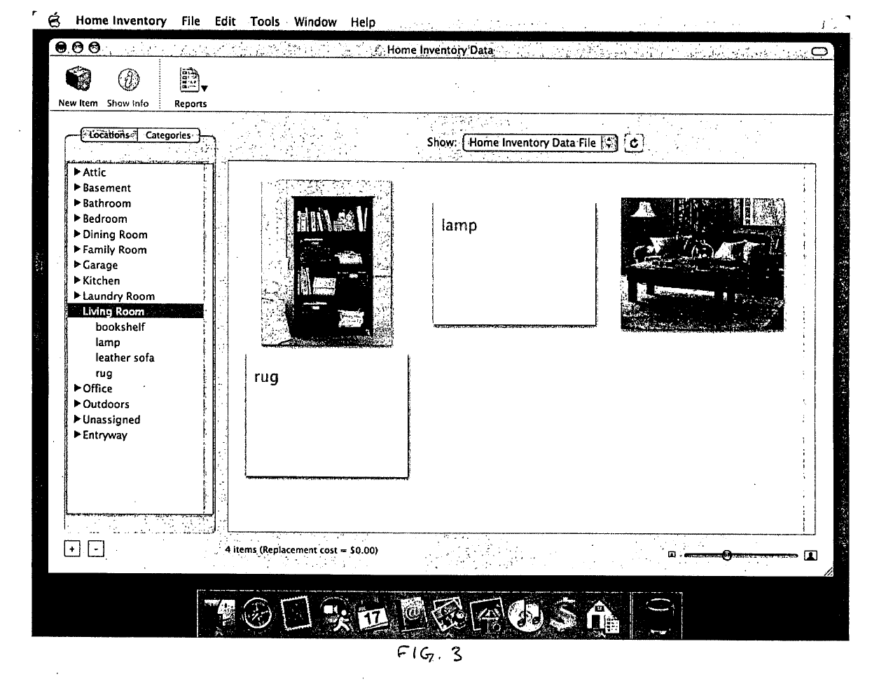

Adding an item for which no image is yet available. In the event that a user wants to add an item to an inventory for which no image is available, the user selects “New Item” from the Edit menu 122 or selects the New Item icon 110. Home Inventory creates an image to represent the item by doing the following. Home Inventory opens the Item Info window 550. If a location or category was selected when the user selected “New Item” or the New Item icon 110, then that location or category is by default assigned to the new item and displayed in the Item Info window 550. If no location or category was selected when the user selected “New Item”, then the default location of “Unassigned” and the default category of “Other” are used. The user can then enter a text label for the item. Home Inventory then generates an image containing the text label that is used as the image representing that item. A copy of the image containing the text label is then saved in an inventory data file, and a reference to the copy is added to the new record for the item, as described above. FIG. 3 shows examples of generated images for the “rug” and “lamp” present in the Living Room Location.

Replace the Image for an Item

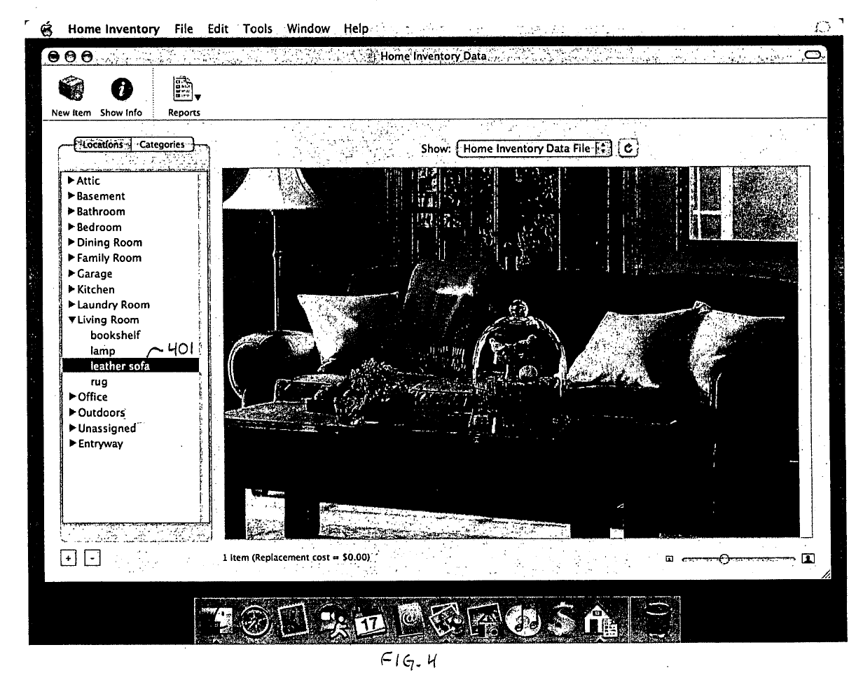

To replace the photo for an item, the user first selects the item from the location or category list. For example, FIG. 4 shows a screen shot after the user has selected “leather sofa” from the Living Room Location. Then the user selects the desired folder that contains the replacement image from the folder options from the Show menu 104. The user selects and drags the new image from the main workspace to the item selected in the location or category list. In the example of FIG. 4, the user drags the new image to the “leather sofa” item 401 selected in the location list. Optionally, when the drag operation is completed, a dialog box to confirm the replacement is displayed and the user selects OK to replace the existing image or Cancel to not replace the existing image.

Changing an Item's Stored Attributes

All of the user-specified and default textual information stored in an item's record can be altered manually. When a user selects an item from the item list in the locations/categories pane 102, 202 or the image of the item from the workspace 103 and selects the Show Info button 105, the Item Info window 550 is opened. An example of the Item Info window 550 is shown in FIG. 5. From this window, the user can manually specify changes to the textual information stored in the item's record. If a user makes changes to Location or Category using this method, the locations/categories pane 102, 202 is then updated to reflect current location and category for each item.

In addition, Location can be dynamically updated in an item's record in response to a user moving an item from one location in the locations list to another location in the locations list. Similarly, Category is dynamically updated in an item's record in response to a user moving an item from one category in the categories list to another category in the categories list. Moving an item from one location or category to another location or category is done either by dragging the text description of the item displayed in the locations/categories pane 102, 202 from one location or category to another, or by dragging the displayed image of the item from the workspace to the desired location or category. To display images in the workspace 103 of all items with a particular location or category, the user selects the location or category from the displayed list in the locations/categories pane 102, 202. The user selects the image displayed in the workspace 103 that corresponds to the desired item and drags it to the desired new location or category. Then, the item's record is automatically updated with the new location or category.

Delete an Item, Location or Category

To delete an item, location, or category, the user selects the item, location, or category from the stored items list in the locations/categories pane 102, 202. Then the user selects the delete button 107 at the bottom of the list. Optionally, when the delete button 107 has been selected, a dialog box to confirm the deletion is displayed, and the user selects OK to delete the item, location or category, or Cancel to cancel the deletion. If a user chooses to delete a category or location where items are stored, the items stored with that category or location are also deleted. Thus, a dialog box is displayed that warns that deleting a location or category will also result in the deletion of the items stored with that location or category as well and asks the user to confirm the deletion. Confirming the deletion of the location or category from the locations/categories list and the deletion of all items stored with that location or category.

In some embodiments, the default location “Unassigned” cannot be deleted, nor can the default category “Other.” Preventing the deletion of the default location “Unassigned” and the default category of “Other” ensures that new items can always be displayed in the locations/categories list under these labels.

Add a Location or Category

To add a location or category to the list of locations or categories, the user selects the appropriate tab for locations 108 or categories 109 from the tabs above the locations/categories pane 102, 202. Then the user selects the Add button 106 below the pane. Home Inventory then adds a new location or category to the end of the list, sets the label for the item to “Untitled,” selects the new item in the list and selects the placeholder label. The user can then easily enter a new name for the new location or category.

Rename a Location or Category

Locations and categories can be renamed. To rename a location or category, the user selects the name of the category or location by double-clicking on it in the list in the locations/categories pane 102, 202. The user can then enter a new name for the location or category.

In some embodiments, the default location “Unassigned” cannot be edited, nor can the default category “Other.” Preventing users from editing the default location “Unassigned” and the default category of “Other” ensures that new items can always be displayed in the locations/categories list under these labels.

III. Insurance Policies

Recording Insurance Policy Information

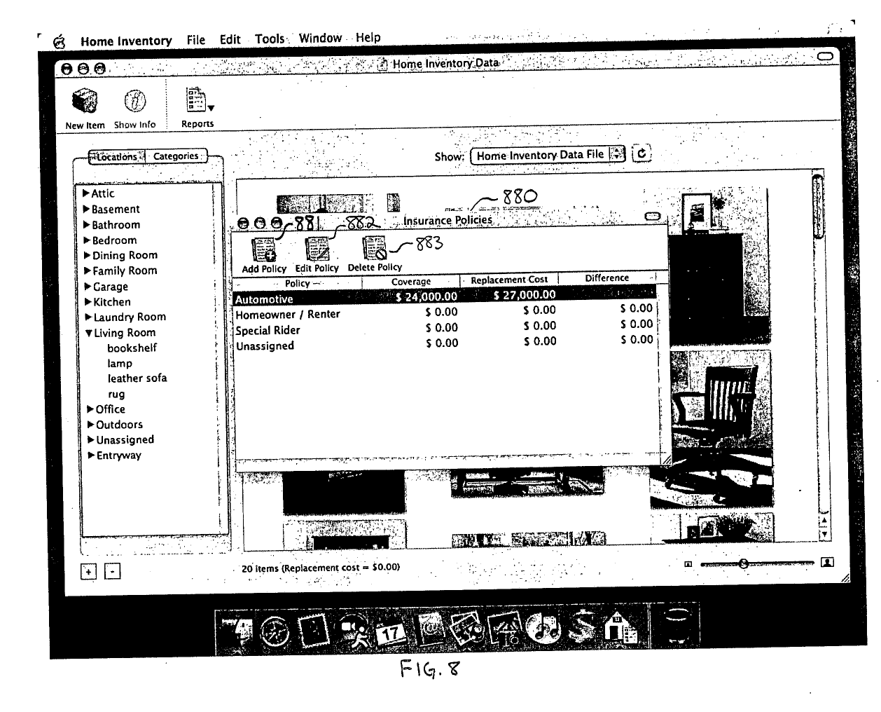

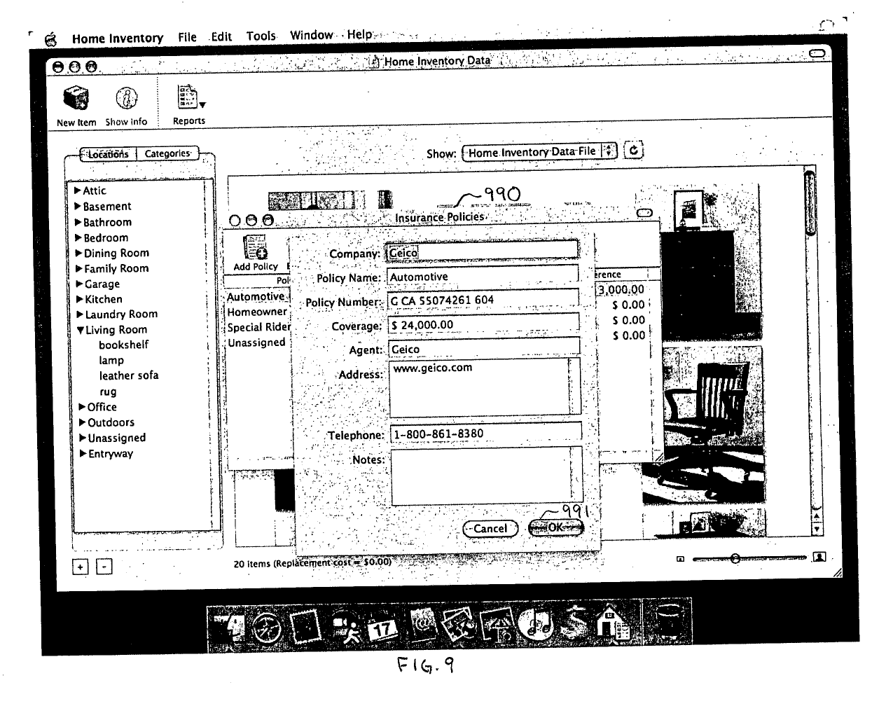

To record insurance policy information, the user selects “Insurance Policies” from the Tools menu 123. Referring to FIG. 8, this opens an insurance policy browser pane 880. Then the user selects Add Policy from the Edit menu 122 or selects the Add Policy icon 881. In response, referring to FIG. 9, an Insurance Policy Info window 990 is then displayed. In this window, the user has the option of entering information such as the insurance carrier name, the policy name, the policy number, the coverage amount, the insurance agent name and contact information, and other notes. When the user selects OK 991, the new policy is saved to the list of policies in the Insurance Policies browser pane 880. Optionally, certain insurance policies may be presented to the user in the Insurance Policies browser pane 880 by default, such as Automotive, Homeowner/Renter, Special Rider, and Unassigned. In some embodiments, for these default policies, only the name of the policy is completed in the Insurance Policy Info window 990.

If the user enters the amount of coverage for a policy, Home Inventory has the functionality to compare the amount of coverage with the total value of the items covered under the policy. To enable Home Inventory to make this determination, the user must also enter the values of the items covered. Each item's value is stored in the record for that item.

Edit an Insurance Policy

A user may edit existing insurance policy information in the list of the insurance policies by selecting the policy from the Insurance Policy Browser 880 and then selecting Edit Policy from the Edit menu 122 or selecting the Edit Policy icon 882. Referring to FIG. 9, the user can then update any of the fields of the insurance policy record in the Insurance Policy Info window 990. When completed, the user selects OK 991. A user may delete an existing insurance policy in the list of insurance policies by selecting the policy from the Insurance Policy Browser 880 and then selecting Delete Policy from the Edit menu 122 or selecting the Delete Policy icon 883.

IV. Reports

Reports are organized summaries of information contained in the inventory data file.

Create a Report

Users can create a variety of reports using Home Inventory. From the Reports menu 111, users select Inventory Detail Report by Category, Inventory Detail Report by Location, Inventory Summary Report by Category, or Inventory Summary Report by Location.

Inventory Detail Reports include thumbnails of images stored for each item next to the associated information for that item stored in the inventory data file for that record. In some embodiments, images are resized according to the following rules:
1. Resize the image until it is 240 pixels wide, and scale the vertical size by the same factor.
2. If the total height for the image after the preceding step will not fit on a new page, scale the vertical size to fit, then scale the horizontal size by the same factor.

A new page is started if the complete image and all the text for that item do not fit on the existing page. Thus, the image and the accompanying text for an item should appear on a single page in most cases.

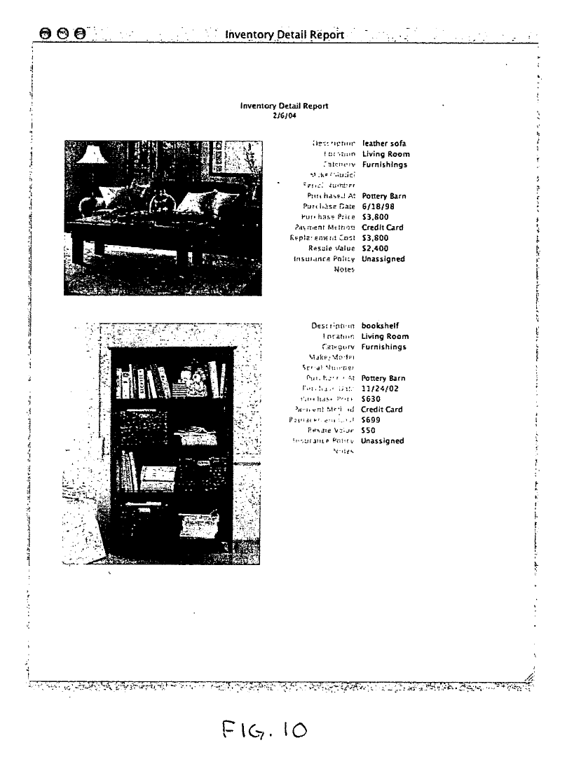

Inventory Detail Report by Location differs from Inventory Detail Report by Category in how the records for items are organized. FIG. 10 shows an example of an Inventory Detail Report for two items in the database.

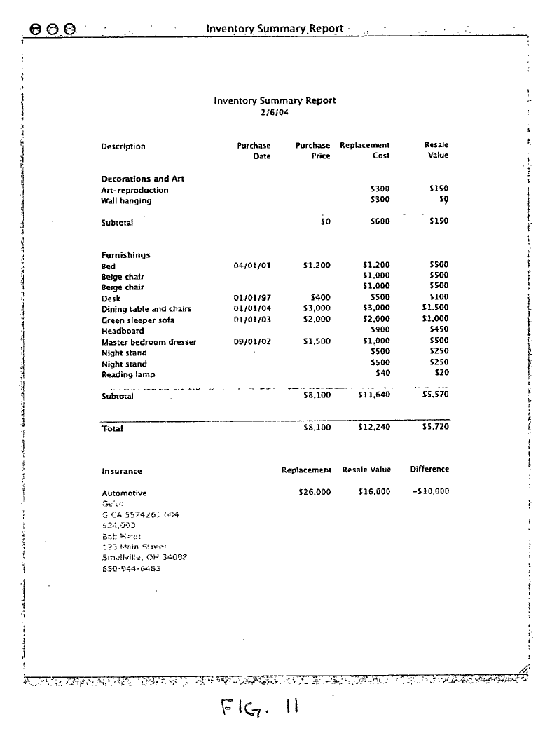

Inventory Summary Reports lists each item in the inventory in subgroups either by Category or Location. FIG. 11 is an example of an Inventory Summary Report. The summary report also displays a table of the purchase date, purchase price, replacement cost and resale value entered for each item. In some embodiments, in a second table in the summary report, the insurance policies are listed with columns for replacement cost, the resale value, and the difference between the coverage amount and replacement cost.

In some embodiments, inventory detail reports and inventory summary reports are customizable by the user. For example, a user may wish to create a report containing only information on items covered by one insurance policy or only information on items contained in one room. The Home Inventory program uses such restrictions to filter the records displayed in the inventory reports.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of generating a record for an item in an inventory database, comprising:
importing at least one image to display in a workspace within a user interface of a inventory software application; and
responsive to a user selecting an image to represent an item to be added to the inventory, generating a record for the item in the inventory database containing a reference to the selected image, wherein the image identifies the database record for the item within the user interface.

2. The method of claim 1, wherein importing at least one image comprises at least one selected from a group consisting of importing from a local file system, importing from a remote file system, importing an image received from a device, and importing an image from an email attachment.

3. The method of claim 1, wherein importing at least one image comprises at least one selected from a group consisting of importing an image captured by digital camera and importing a sample image.

4. The method of claim 1, further comprising adding text descriptions to inventory database records.

5. The method of claim 1, wherein the inventory database is part of a financial services software package.

6. The method of claim 1, wherein the record for the item in the inventory database contains a down sampled version of the selected image.

7. The method of claim 1, wherein further responsive to a user selecting an image to represent an item to be added to the inventory, assigning a unique identifier to the new record.

8. The method of claim 1, wherein the reference to the selected image comprises a reference to a copy of the selected image.

9. The method of claim 1, wherein the inventory software application comprises one of a home inventory software application and a business inventory software application.

10. A computer-implemented method of updating an inventory database record for an item, the record comprising an image and an attribute, the method comprising:
displaying in a workspace an image stored in an inventory database record for an item, the image identifying the inventory database record for the item;
responsive to the displayed image being moved from the workspace to an attribute descriptor within a list of attribute descriptors, updating the attribute in the inventory database record for the item.

11. The method of claim 10, wherein the attribute is a physical location of the item.

12. The method of claim 10, wherein the attribute is a category of the item.

13. The method of claim 10, wherein the list of attribute descriptors is hierarchical.

14. A user interface for an inventory database, comprising:
a workspace for displaying images identifying inventory database records of items; and
a pane for displaying a list of attributes, wherein responsive to the displayed image being moved from the workspace to an attribute descriptor within a list of attribute descriptors, updating the attribute in the inventory database record for the item.
